(19) United States
(12) Patent Application Publication
(10) Pub. No.: US 2007/0033845 A1
(43) Pub. Date: Feb. 15, 2007

(54) Vehicle adornment apparatus and method of use thereof

(76) Inventor: Clarence Richard Sherman JR., Athol, NY (US)

Correspondence Address: SCHMEISER, OLSEN & WATTS, 22 CENTURY HILL DRIVE, SUITE 302, LATHAM, NY, 12110, US

(21) Appl. No.: 11/199,680

(22) Filed: Aug. 9, 2005

(51) Int. Cl. G09F 7/00

(52) U.S. Cl. 40/611.01

(57) ABSTRACT

A vehicle adornment apparatus is provided that affords the ability to permanently vacuum mount a base plate to a vehicle body and removably attach an emblem plate to the base plate. The emblem plate may be interchanged with another removably attachable emblem plate operable with the base plate. Moreover, the emblem plate may include an ornamental design protrusion.

### BACKGROUND OF INVENTION

1. Technical Field

This invention relates generally to the adornment of vehicles. More particularly, this invention provides for a vehicle adornment apparatus including a base plate and an interchangeable emblem plate and a corresponding method of use thereof.

2. Related Art

Vehicle owners often desire to adorn their vehicles with various implements to modify the look of the vehicles. In this regard, common vehicle adornment devices/methods have, in general, provided fixtures, covers, plates and other similar components that can be attached to a vehicle body. These components must be securely attached to the vehicle in order to ensure that they do not become detached from the vehicle during use. Several methods of securing such components are available to vehicle owners. However, each of such methods comes with certain drawbacks. One method available is to use a screw or other fastening device to attach the component to an area of the vehicle body. This creates difficulty because the vehicle either has to have an available hole ready to accept the adornment, or a new hole has to be made in the vehicle body. Most vehicles will not have the necessary holes already in place, and drilling holes causes structural damage to the vehicle. There is also the possibility of welding the attachment to the vehicle. This can be dangerous and impractical depending on the location of the welding (e.g. the gas tank of a motorcycle). A final possibility is to attach the component using some type of adhesive. This creates an adornment that is difficult to remove once it is attached permanently. Therefore, the vehicle owner would be unable to change the adornment of the vehicle once the attachment is affixed.

Accordingly, there is a need for a vehicle adornment apparatus/method where a component can be added to any vehicle's body in a permanent nature, without structurally damaging the vehicle or dealing with impracticalities. There is also a need for users of the apparatus/device to be able to interchange different designs to adorn their vehicle quickly and easily as their preferences change.

### SUMMARY OF INVENTION

The present invention is directed to an air treatment apparatus that offers improved operability.

A first general aspect of the invention provides for a vehicle adornment apparatus comprising a base plate, configured to be vacuum sealed to a portion of a vehicle body, and an emblem plate, configured to be removably attached to said base plate.

A second general aspect of the invention provides for a method of adorning a vehicle comprising the steps of providing a vehicle adornment apparatus having a base plate, configured to be permanently attached to a portion of a vehicle body, and an emblem plate, configured to be removeably attached to said base plate, permanently attaching the base plate to the portion of the vehicle body, and removably attaching the emblem plate to the base plate

A third general aspect of the invention provides for a vehicle adornment apparatus comprising a first plate configured to be permanently attached to a portion of a vehicle body, and a second plate configured to be detachably and reattachably mounted to said base wherein said second plate contains an ornamental design protrusion.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a side view of one embodiment of a vehicle adornment apparatus in accordance with the present invention as mounted on a body portion of a vehicle;

FIG. 2 depicts a top exploded view of the embodiment of the vehicle adornment apparatus prior to mounting on the vehicle shown in FIG. 1;

FIG. 3 depicts a side view of one embodiment of a first plate or base plate;

FIG. 4 depicts a top view of one embodiment of a first plate or base plate;

FIG. 5 depicts a top view of two first plates or base plates mounted oppositely on mirrored body portions of a vehicle;

FIG. 6 depicts a side view of the embodiment of a second plate or emblem plate shown in FIG. 2, in accordance with the present invention;

FIG. 7 depicts a bottom view of the embodiment of a second plate or emblem plate shown in FIG. 2, in accordance with the present invention;

FIG. 8 depicts a side view of another embodiment of a second plate or emblem plate;

FIG. 9 depicts a bottom view of the other embodiment of a second plate or emblem plate shown in FIG. 8;

FIG. 10 depicts a side view of a further embodiment of a second plate or emblem plate;

FIG. 11 depicts a bottom view of the further embodiment of a second plate or emblem plate shown in FIG. 10;

FIG. 12 depicts the interchangeability of the second plate or emblem plate.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

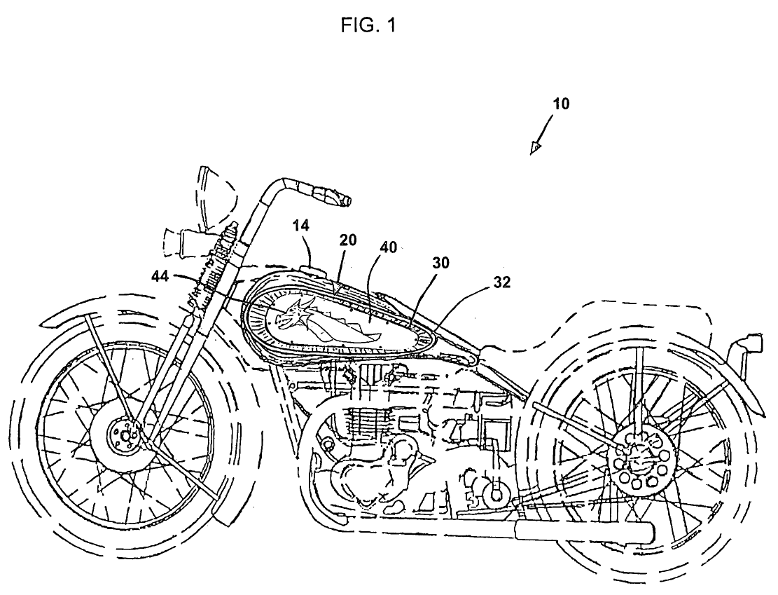

Referring to the drawings, FIG. 1 depicts a side view of one embodiment of a vehicle adornment apparatus 20 in accordance with the present invention as mounted on a body portion 12 of a vehicle 10. Although the vehicle 10 is depicted as a motorcycle those in the art will appreciate that the vehicle 10 may be a car, truck, van, bus, recreation vehicle, camper, all-terrain vehicle, sport utility vehicle, bicycle, scooter, boat, jet-ski and/or any other like vehicles. The body portion 12 of vehicle 10 may be an exterior surface of the vehicle 10 such as a hood, door, fender, trunk, roof, gas tank, oil tank, exhaust system, hull and/or other like surfaces and/or combinations thereof. The vehicle adornment apparatus 20 may be mounted on body portion 12, such as the external gas tank of a motorcycle as embodied in FIG. 1. The motorcycle gas tank may include a top central gas cap 14.

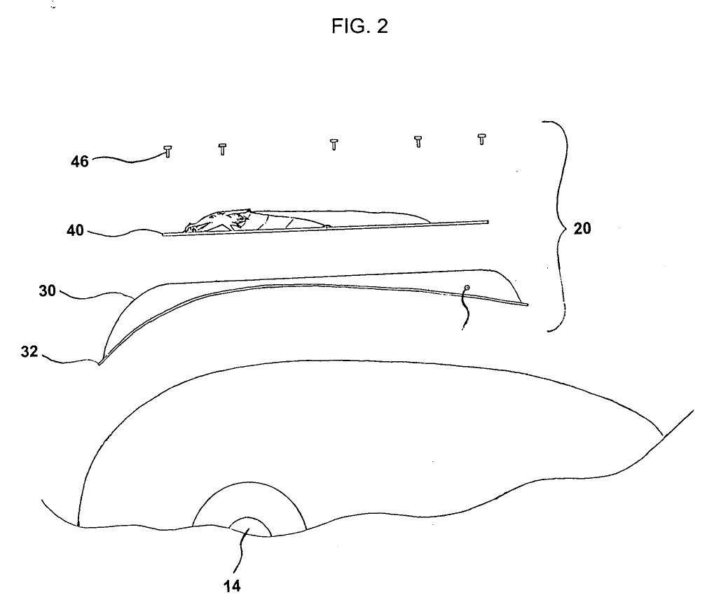

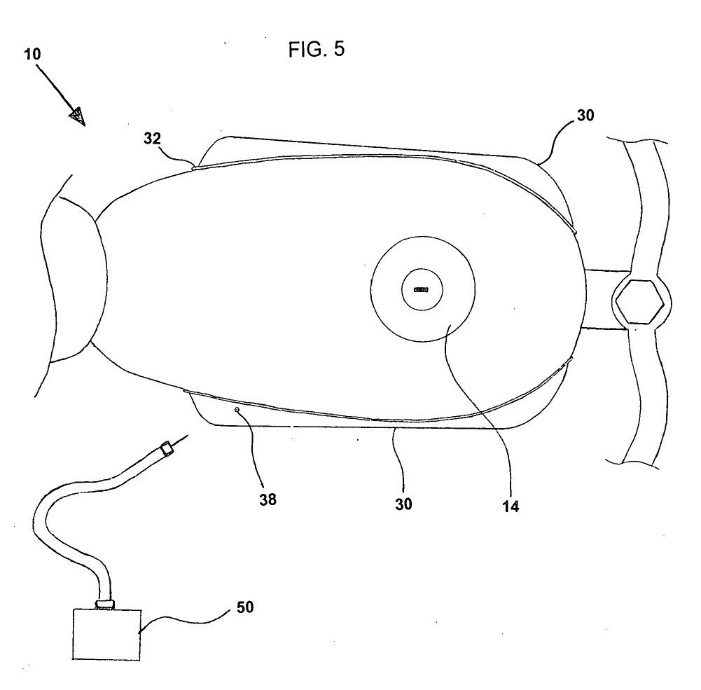

Referring further to the drawings, FIG. 2 depicts a top exploded view of the embodiment of the vehicle adornment apparatus 20 prior to mounting on the vehicle 10 shown in FIG. 1. The vehicle adornment apparatus 20 may be attached to any portion of the vehicle 10 that is suitable for attaching a vehicle adornment apparatus 20 thereto. For example, the vehicle adornment apparatus 20 may be mounted on the external gas tank of a motorcycle as embodied in FIG. 1 (see also FIGS. 2 and 5). The vehicle adornment apparatus 20 includes a first plate or base plate 30 configured to be permanently attached to the body portion 12. For example, the vehicle adornment apparatus 20 may be shaped or have curvature such that it corresponds to the shape or curvature of the body portion 12 such as the gas tank of a motorcycle. The vehicle adornment apparatus 20 may also include a second plate or emblem plate 40 configured to be removably attached to the base plate 30. The second plate or emblem plate 40 may operate with at least one fastener element 46 to facilitate removable attachment of the emblem plate 40 to the base plate 30. The at least one fastener 46 may consist of any attachment means known in the art such as screws, hooks, hook-and-loop fasteners, magnets, snaps, clamps, double-sided tape and/or any other like attachment elements and/or combinations thereof. The fastener element 46 may be a distinct element or may be integral to the second plate or emblem plate 40. For example, the second plate or emblem plate 40 may contain an extension that slides into a groove located on the first plate or base plate 30 to facilitate attachment. Alternatively, the second plate or emblem plate 40 may contain a groove that allows slideable attachment with an extension of the first plate or base plate 30.

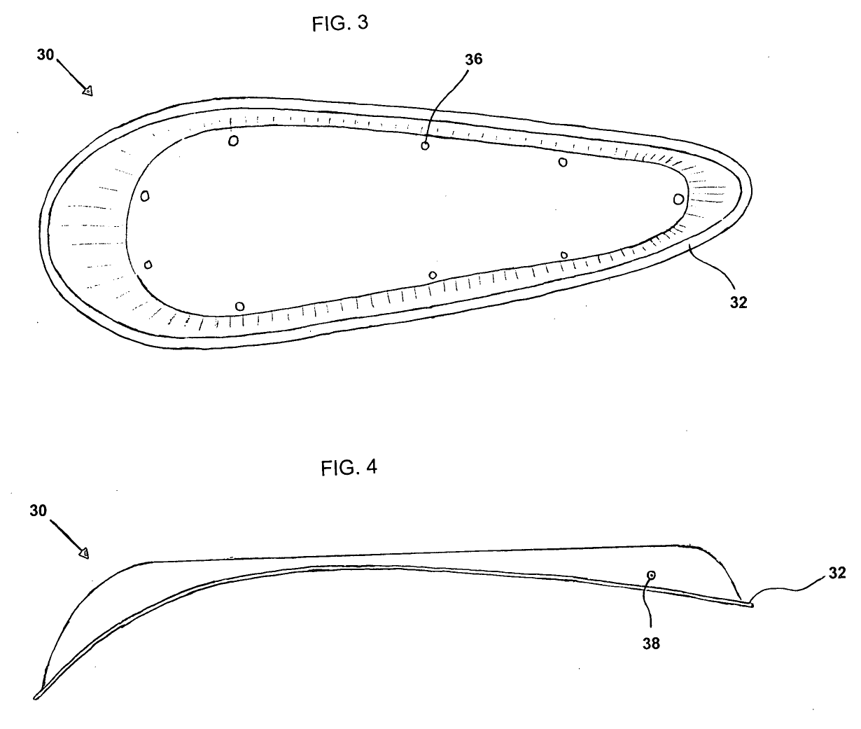

Referring further still to the drawings, FIG. 3 depicts a side view of one embodiment of a first plate or base plate 30. The first plate or base plate 30 may be formed of a metal such as sheet metal. Alternatively, the base plate 30 may be constructed of any solid material known to those in the art that is suitable for the purposes described herein. Such materials may include a polymeric material, wood, composites, metal alloys, rubber and/or other like materials and/or combinations thereof capable of being vacuum sealed to the body portion 12 of a vehicle 10 (shown in FIG. 1). While the embodiment of the first plate or base plate 30 may be fabricated into a configuration to be attached to an external gas tank of a motorcycle, one skilled in the art would also appreciate that the first plate or base plate 30 may be sized and shaped to be applied to any portion of a vehicle 10. For example, the first plate or base plate 30 may have physical dimensions corresponding to a fender of a motorcycle, shown in dashed lines in FIG. 1.

Referring still to FIG. 3, the first plate or base plate 30 may also have a lip 32 surrounding the outside edge which may provide a greater contact surface when the first plate or base plate 30 is applied to a body portion 12, such as the external gas tank of a motorcycle, and may be sized as necessary to achieve its intended purpose. The lip 32 may serve to receive an adhesive to attach the first plate or base plate 30 to the body portion 12 of vehicle 10 (see FIG. 1) prior to vacuum sealing. The lip 32 may be made of any solid material known to those in the art that is suitable for the purposes described herein, including materials such as sheet metal, a polymeric material, wood, composites, metal alloys, rubber and/or other like materials and/or combinations thereof. The lip 32 may be formed integrally as part of the first plate or base plate 30 and/or may be a separately affixed component. As such, the lip 32 may be made of the same material as the first plate or base plate, or a different material. In one embodiment, the lip 32 may be made of a more flexible material, with greater elasticity, such that an enhanced form fit can be obtained between the lip 32 and the first plate or base plate 30. The first plate or base plate 30 may have at least one attachment element 36 located thereon. The attachment element 36 may be located anywhere on the first plate or base plate 30, and may consist of any attachment means known in the art such as threaded holes to receive screws, hooks, hook-and-loop fasteners, magnets, grooves, channels, ridges, lips, tracks, snaps, clamps, double-sided tape and/or any other like attachment elements and/or combinations thereof. The attachment element 36 may correspond to a fastener element 46 operable with the second plate or emblem plate 40 as depicted in FIG. 2. For example, the first plate or base plate 30 may include an integral groove attachment element 36 allowing slideable attachment to the second plate or emblem plate 40. The first plate or base plate 30 may be manufactured through any technique known to those in the art. For example, the first plate or base plate 30 may be stamped, pressed, rolled, injection molded, cast, thermal formed, shaped, bored, cut and/or welded.

With additional reference to the drawings, FIG. 4 depicts a top view of the embodiment of FIG. 3 of the base plate 30. The first plate or base plate 30 may be shaped and configured in any manner necessary for its intended purpose, such that it may be vacuum-sealed to a body portion 12, such as the external gas tank of a motorcycle as embodied in FIG. 1. The inside of the first plate or base plate 30 may be hollow to conform to the shape of a body portion 12 such as the external gas tank of a motorcycle as embodied in FIG. 1. Furthermore, the hollow portion of the first plate or base plate 40 may accommodate a pre-existing logo, mechanical component, or other like component that may protrude from the body portion 12. The first plate base plate 30 may have a thickness such that it may have threaded holes to receive screws. In one embodiment, the first plate or base plate may have an aperture 38 located thereon in order to facilitate the vacuum sealing. The aperture 38 may be located anywhere on the first or base plate 30, and may be in the form of a hole, slit, opening, slot, notch, cavity and/or any other form that allows the entry and/or engagement of a needle or other like drawing element to facilitate creation of a vacuum seal. The aperture may be configured to assist in the development of a vacuum between the first plate or base plate 30 and the body portion 12, such as a motorcycle gas tank (shown in FIG. 2). The aperture 38 may include a rubber valve, or other equivalents to maintain the vacuum seal when the needle used to create the vacuum seal is removed. Moreover, the aperture may be operable with a standard pneumatic tool connection.

Referring once again to the drawings, FIG. 5 depicts a top view of two first plates or base plates mounted oppositely on mirrored body portions of a vehicle. A first plate or base plate 30 may be attached to a body portion 12 prior to vacuum sealing using an adhesive such as an epoxy, glue, double-sided tape, and/or any other like adhesive and/or any combination thereof. The shape of the first plate or base plate 30 may assist in mounting to the body portion 12 as the shape may be substantially similar to the body portion 12. The adhesive may be applied to the lip 32 of the first plate or base plate 30. The first plate or base plate 30 may be configured such that it can be vacuum-sealed using the vacuum pump 50 or other vacuum sealing means. Moreover, the adhesive may be applied directly to the body portion 12 of the vehicle 10. The vacuum pump 50 may be a hand-held portable or stationary pump. Furthermore, the vacuum pump 50 may be hand-operated, battery operated, electric, or any other type of vacuum pump suited for the intended purpose. In an embodiment, the user may operate the vacuum through aperture 38 of the first plate or base plate 30. Alternatively, the first plate or base plate 30 may be configured such that a needle could pass underneath the lip 34 in order to effectuate the vacuum sealing. The use of the vacuum seal may allow the first plate or base plate 40 to be firmly attached to the body portion 12 and may facilitate the creation of an airtight seal without the use of pre-existing structures on the vehicle 10, without the use of welding, and without structurally damaging the vehicle 10.

Referring still to FIG. 5, the first plate or body plate 30 may be designed such that it is symmetrical. For example, the first plate or body plate 30 may be shaped such that it could be applied to either a left side or right side body portion 12 of a vehicle 10 so long as the body portions 12 are mirror images of one another. Alternatively, the first plate or base plate 30 could be designed such that it is specifically adapted to be placed only on particular portions of a vehicle 10, such as the right or left side of the vehicle 10.

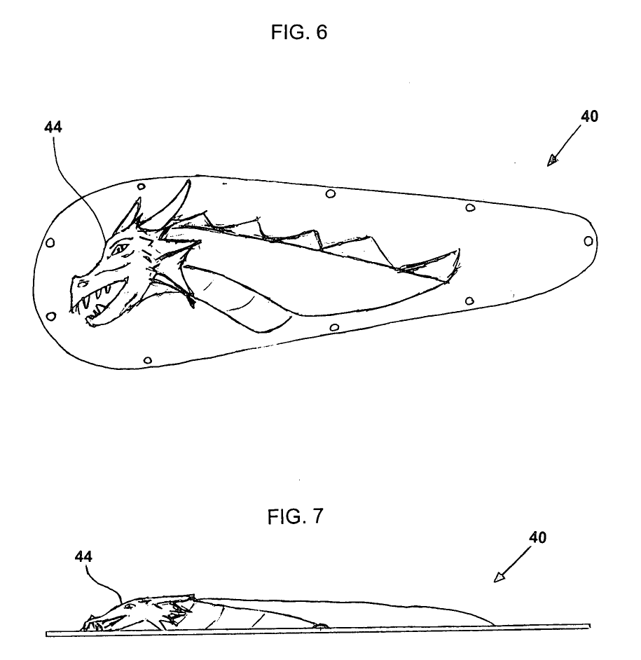

FIGS. 6-11 depict several embodiments of the second plate or emblem plate 40. The embodiments may be configured for use on the external gas tank of a motorcycle. The second plate or emblem plate 40 may be made of any material suitable for its intended purpose. Such material may include sheet metal, a polymeric material, wood, composites, metal alloys, rubber, blown glass and/or other like materials and/or combinations thereof. The emblem plate 40 may also have various shapes, such shape corresponding to the first plate or base plate 30 (as shown in FIG. 3).

Each second plate or emblem plate 40 may also have a design 44 appearing on its front surface. Such design 44 may include flames, geometric shapes, animals, lightning bolts, logos, lettering, numbers, pictures and/or any other like designs and/or combinations thereof. Furthermore, the design 44 may be a protrusion that extends outward from the emblem plate 40 as depicted in the top views of FIGS. 7, 9 and 11. Such design 44 may be an ornamental design protrusion. The second plate or emblem plate may be suited to receive different types of paints, including but not limited to fluorescent paints. In another embodiment, the emblem plate 40 may contain lights, LED's, fiber-optics and/or any other similar features. The user may operate the lights using a switch that the user will have access to while the vehicle 10 is being operated. Alternatively, the lights may be activated by specific operations of the vehicle 10 itself, such as the depression of the accelerator. The second plate or emblem plate 40 may be manufactured in any manner known to those skilled in the relevant art. For example, the second plate or emblem plate 40 may be stamped, pressed, rolled, injection molded, cast, thermal formed, shaped, bored, cut, blown, and/or welded.

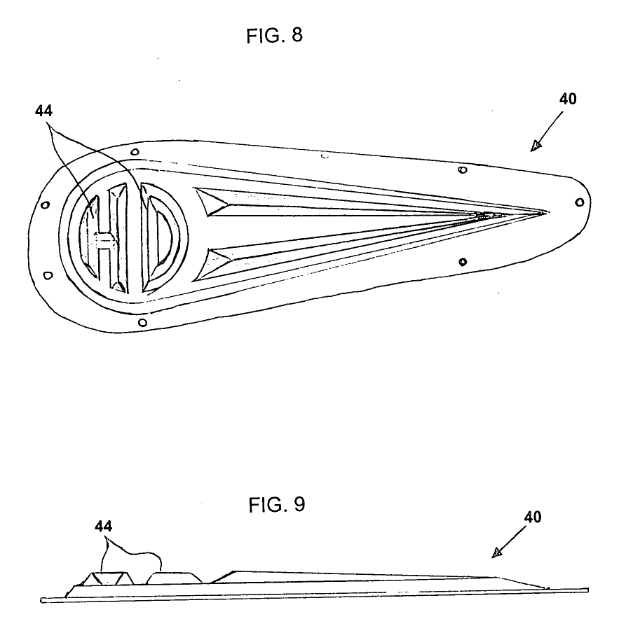

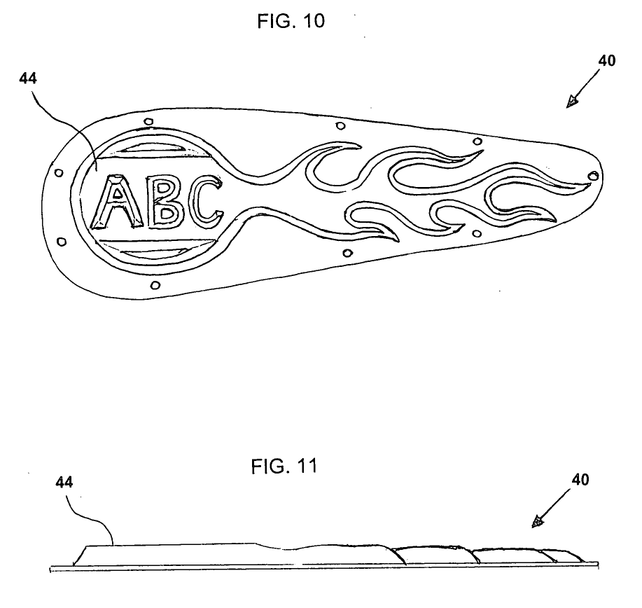

Referring to the drawings, FIG. 6 shows one embodiment of the second plate or emblem plate 40a where the raised portion displays a dragon. FIG. 8 depicts another embodiment of an emblem plate with raised lettering and geometric shapes. Finally, FIG. 10 shows a further embodiment of an emblem plate 40 having a flame design with accompanying lettering thereon.

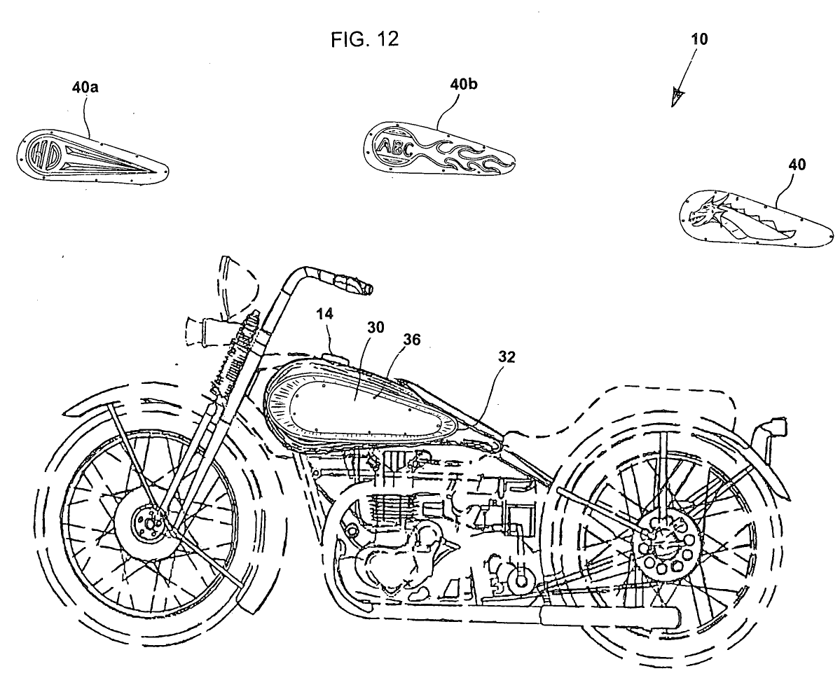

Referring once again to the drawings, FIG. 12 depicts the interchangeability of an emblem plate 40 with a base plate 30. A user may attach the emblem plate, such as the embodiments in 40, 40a, and 40b to the base plate 30 interchangeably to suit user preference through a simple adjustment or element swap. This allows the user to display an element of individuality by changing the design of his/her vehicle 10 to semi-customize.

The vehicle adornment apparatus 20 (as shown in FIG. 2) may be mass-produced and distributed. Moreover, the vehicle adornment apparatus 20 may be sold as a kit. For example, a customer may be able to purchase a kit that contains both a first plate or base plate 30 and a second plate or emblem plate 40, as well as the at least one fastener element 46. Additionally, the kit could contain an adhesive as well as a vacuum pump 50 (as shown in FIG. 5). As such, the kit would provide the user with the elements needed to adorn their vehicle. This may allow a user to a purchase an affordable apparatus that may be applied to a vehicle in order to create an adornment. No specific skills or tools (other than those provided in the kit) would be required to employ the vehicle adornment apparatus. Installation of the vehicle adornment apparatus 20 would be fairly easy, as the user only has to apply the vehicle adornment apparatus 20 to the vehicle 20 and use the vacuum pump 50 to create a seal. As a result, the customer would have no need to take their vehicle to an auto body shop in order to attach the vehicle adornment apparatus 20, or to interchange a second plate or emblem plate 40 once the vehicle adornment apparatus 20 is installed.

Alternatively, the elements of the vehicle adornment apparatus 20 could be sold separately. For example, a customer could purchase the first plate or base plate 30 with the second plate or emblem plate 40 and then buy additional emblem plates (such as 40a or 40b as shown in FIG. 12). The at least one fastener element 46 may also be sold separately as a replacement. Finally, the vehicle adornment apparatus 20 may be adapted to be applied to any body portion 12 of any vehicle 10. This provides the customer with many options in adorning their vehicle 10, allowing the customer to achieve a semi-customization.

The present invention also provides a method of adorning a vehicle. The method may involve providing a vehicle adornment apparatus 20 (as shown in FIG.2) having a first plate or emblem plate 40 configured to be permanently attached to a body portion 12 of a vehicle 10, such as the gas tank of a motorcycle, and a second plate or emblem plate 40 configured to be removeably attached to the first plate or base plate 30. The method may further include a step of permanently attaching the first plate or base plate 30 to the body portion 12 of the vehicle 10. The first plate or base plate 30 may be vacuum-sealed to the body portion 12 using an embodiment of a vacuum pump 50 (as shown in FIG. 5). Additionally, the method involves a step of removably attaching the second plate or emblem plate 40 to the first plate or base plate 30. The attachment may be achieved using at least one fastener element 46. The method may further include the step of interchanging among different second plate or emblem plates 40 (as shown in FIG. 12). This step could include detaching the second plate or emblem plate 40 and applying another plate. The step may then be repeated with yet another emblem plate, or second 40 that may be attached. The method may also include the step of operating lights that may be located on or operable with the second plate or emblem plate 40 and/or the base plate 30. The lights could be synchronized to represent moving flames, waving flags, blinking eyes, etc.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A vehicle adornment apparatus comprising:
a base plate, configured to be vacuum sealed to a portion of a vehicle body;
and
an emblem plate, configured to be removably attached to said base plate.

2. The vehicle adornment apparatus of claim 1, wherein the emblem plate includes an ornamental decoration defined by a protrusion.

3. The vehicle adornment apparatus of claim 1, wherein the emblem plate include lights.

4. The vehicle adornment apparatus of claim 1, wherein the vehicle is a motorcycle.

5. The vehicle adornment apparatus of claim 4, wherein the portion of the vehicle body is an external gas tank of the motorcycle.

6. The vehicle adornment apparatus of claim 1, wherein the base plate has a lip around the outside edge.

7. The vehicle adornment apparatus of claim 1, said vehicle adornment apparatus having a symmetrical configuration.

8. A vehicle adornment apparatus comprising:
a first plate configured to be permanently attached to a portion of a vehicle body; and
a second plate configured to be detachably and reattachably mounted to said base,
wherein said second plate contains an ornamental design protrusion.

9. The apparatus of claim 8, wherein the first plate is vacuum-sealed to the portion of the vehicle body.

10. The apparatus of claim 8, wherein the vehicle is a motorcycle.

11. The apparatus of claim 10, wherein the portion of the vehicle body is an external gas tank of the motorcycle.

12. The vehicle adornment apparatus of claim 8, wherein the emblem plate include lights.

13. The apparatus of claim 8, wherein the base plate includes a lip around the outside edge.

14. The vehicle adornment apparatus of claim 8, said vehicle adornment apparatus having a symmetrical configuration.

15. The vehicle adornment apparatus of claim 14 oppositely mountable on a mirrored body portion of the vehicle.

16. A method of adorning a vehicle comprising the steps of:
providing a vehicle adornment apparatus having:
a base plate, configured to be permanently mounted to a portion of a vehicle; and
an emblem plate, configured to be removably attached to said base plate;
permanently attaching the base plate to the portion of the vehicle body; and
removably attaching the emblem plate to the base plate.

17. The method of claim 16 further comprising the step of detaching the emblem plate from the base plate.

18. The method of claim 17 further comprising the step of interchangeably attaching another embodiment of an emblem plate.

19. The method of claim 18 further comprising the step of detaching the other embodiment of the emblem plate.

20. The method of claim 16 further comprising the step of operating lights on the emblem plate.
